(19) United States
(12) Patent Application Publication
(10) Pub. No.: US 2016/0113296 A1
(43) Pub. Date: Apr. 28, 2016

(54) Ready-To-Bake Gluten-Free Pie Dough Formulations

(71) Applicant: GENERAL MILLS, INC., Minneapolis, MN (US)

(72) Inventors: Christine O'Connor, Rogers, MN (US); Michelle Dacey, Golden Valley, MN (US)

(73) Assignee: General Mills, Inc., Minneapolis, MN (US)

(21) Appl. No.: 14/894,086

(22) PCT Filed: May 31, 2013
(86) PCT No.: PCT/US13/43778

§ 371 Date: Nov. 25, 2015

(51) Int. Cl. A21D 10/02; A21D 13/06; A21D 10/00

(52) U.S. Cl. CPC A21D 10/025; A21D 10/002; A21D 13/066

(57) ABSTRACT

A composition includes a gluten free flour mixture constituting from 31% to 50% by weight of the composition, at least one oil constituting from 4.5% to 5.5% by weight of the composition, shortening constituting from 20% to 30% by weight of the composition, fructose constituting from 1% to 4.5% by weight of the composition, water constituting from 20% to 25% by weight of the composition, and sucrose constituting less than 5% by weight of the composition. The composition has a water activity of 0.94 or less and a pH of 7 or less. Methods of manufacturing the composition are also provided.

### BACKGROUND

Gluten is a protein found in a variety of grains including wheat, rye, and barley, with wheat containing the highest levels of gluten when compared to other cereal grains. Although wheat flour is typically referred to as containing gluten, in reality, wheat flour contains two proteins, gliadin and glutenin, which when hydrated combine to form gluten.

Gluten is responsible for the texture and taste of wheat flour-based baked goods such as cookies, brownies, and breads. Upon hydration, gluten forms a network of fine strands that give the dough structure and the capacity to stretch and/or rise during baking. The elasticity of gluten enables the dough to trap gases, which create open cellular structures upon baking.

Gluten also affects the viscosity of dough. As described above, gluten forms the structure of the dough. The extent of the network of gluten strands impacts whether a mixture is thin and runny, like a batter, or is thick, like a dough. For pie dough, wheat flour can make up between 50% and 65% by weight of the dough.

Some individuals are sensitive or intolerant to gluten. Recently there has been a growing trend to provide gluten-free baked goods. While consumers are demanding gluten-free products, it is very difficult to produce gluten-free products having a similar taste and texture as traditional gluten and/or wheat flour containing products because, as described above, gluten provides the structure or framework for traditional baked goods. When the wheat flour is replaced with gluten-free flour such as rice flour, the dough lacks the matrix to create the structure and texture typically associated with comparable gluten containing baked goods. For example, gluten-free dough may not have the same elasticity as a gluten containing dough, may be more difficult to handle.

Currently, gluten-free pie dough dry mixes are commercially available. Such dry mixes require the consumer to add ingredients, such as vinegar, eggs, solid fat and water, to a provided dry mixture. These mixes tend to produce doughs and baked products that may not be as satisfying as the gluten containing products. For example the taste, texture and mouth feel of the baked product may not be as satisfactory as compared to a gluten containing baked product and the baked product may be dry and have a crumbly and/or a gritty texture.

Further, consumers enjoy the modern convenience of ready-to-bake products which can go directly from the pantry, refrigerator or freezer to the oven or other associated baking appliance without the need for additional preparation steps and/or the addition of ingredients. Particularly, there is demand for ready-to-bake gluten-free products that can go directly from the refrigerator to the oven or other associated baking appliance.

Ready-to-bake gluten-free dough adds additional challenges including shelf stability, dough handling properties and the inability for consumers to adjust or manipulate the ingredients of the dough. Ready-to-bake products must be capable of being stored under refrigerated conditions for an extended period of time (i.e., at least 75 days, at least 90 days, or for up to 120 days).

Ready-to-bake doughs also face the additional challenge that the consumers cannot change or adjust the ingredients of the dough. Unlike dry mixes in which the consumer can adjust the amount of certain ingredients added to the dough to adjust the composition, the consumer is unable to add or adjust the content of a ready-to-bake dough.

### SUMMARY

The present invention relates to a shelf stable, ready-to-bake gluten-free pie dough formulations and methods of making these formulations.

According to some embodiments, the ready-to-bake pie dough includes a gluten free flour mixture constituting from 31% to 50% by weight of the dough, at least one oil constituting from 4.5% to 5.5% by weight of the dough, shortening constituting from 20% to 30% by weight of the dough, fructose constituting from 1% to 4.5% by weight of the dough, water constituting from 20% to 25% by weight of the dough, and sucrose constituting less than 5% by weight of the dough. The dough has a water activity of 0.94 or less and a pH of 7 or less.

In another embodiment, a raw dough product is manufactured by combining rice flour, at least one of sorghum flour, potato starch, corn starch and combinations thereof, oil, shortening, fructose and water, forming a raw dough product and packaging the raw dough product. The raw dough product has a water activity of 0.94 or less and a pH of 7 or less.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION

The current invention relates to ready-to-bake gluten-free pie dough formulations. In some embodiments, the gluten-free pie dough resembles gluten containing pie dough, is capable of being stored for a long period of time without the need for hermetic or pressurized sealing, and produces a baked product similar to that obtained with a gluten containing dough.

According to some embodiments, the ready-to-bake gluten-free pie dough includes a flour mixture, oil, shortening, fructose, water, and sucrose. Gluten-free pie doughs according to embodiments of the present invention contain less than 20 ppm gluten and more particularly less than 0% by weight of gluten. In some embodiments, gluten content may be determined based on the gliadan component. A suitable method for determining the gluten content of a food product is provided in Association of Analytical Communities (AOAC) Official Method 991.19: Gliadin as a Measure of Gluten in Foods (final action 2001).

In some embodiments, the pie dough may include from about 44% to about 60% fat and liquid ingredients by weight of the dough and from about 32% to about 64% dry ingredients, including the flour mixture and sucrose, by weight of the dough.

The flour mixture may include, consist essentially of or consist of rice flour, sorghum flour, potato starch and corn starch. It has been found that this flour mixture has a neutral flavor and a tender texture when mixed with the remaining ingredients of the ready-to-bake pie dough, (i.e., shortening, water and other minor pie dough ingredients). In some embodiments, the flour mixture may be present in the ready-to-bake gluten-free pie dough in an amount from about 31% to about 50% by weigh of the dough, and more particularly from about 39% to about 44% by weight of the dough.

The gluten-free flour mixture is a substitute for wheat flour and other gluten containing flours traditionally used in pie dough. The combination of the flour mixture with other ingredients contained in the gluten-free pie dough described herein provide a ready-to-bake pie dough having taste, texture and rheology similar to that of gluten containing dough, and provide baked products comparable to gluten containing baked goods.

The flour mixture may include useful relative amounts of flour and starch. According to some embodiments, the flour mixture can contain up to 75% starch by weight of the gluten-free flour mixture. In other embodiments, the mixture can contain from 65% to 75% starch based on the total weight of the gluten-free flour mixture. In still other embodiments, the mixture can contain from 68% to 73% starch based on the total weight of the gluten-free flour mixture.

The flour mixture includes rice flour, which is free of gluten (i.e., does not contain any measurable amount of gluten or the two protein that comprise gluten, gliadin and glutenin). Suitable forms of rice flour include long or short grain white or brown rice. To prevent gritty baked products, the dough may include less than about 15% by weight of rice flour, and more particularly less than about 9% by weight of rice flour. For example, rice flour may be present in an amount from about 4% to about 15% by weight of the dough, and more particularly in an amount from about 7% to about 9% by weight of the dough.

Because rice flour is not a direct substitute for wheat flour, the flour mixture may also include sorghum flour and additional starches to provide additional structural and textural properties to the dough that cannot be accomplished by the use of rice flour alone. Similar to rice flour, sorghum flour does not contain gluten, gliadin or glutenin. In some embodiments, the gluten-free flour mixture may include less than about 8% sorghum flour by weight of the dough, and more particularly, less than about 6% sorghum flour by weight of the dough. For example, sorghum flour may be present in an amount from about 4.5% to about 8% by weight of the dough, and more particularity in an amount from about 5% to about 6% by weight of the dough.

The flour mixture may further include additional starches. In some embodiments, the flour mixture may include at least one of potato starch and corn starch. In some embodiments, the starch(s) may be native or unmodified starch(s). In other embodiments, the starch(s) may be modified starch(s). Modified starches can be prepared by physically, enzymatically or chemically treating the native starch to change the properties of the starch. The inclusion of potato starch and corn starch into the ready-to-bake pie dough may provide a dough texture similar to wheat based dough without creating off-flavors. In some embodiments, potato starch, corn starch or combinations thereof are present in an amount of not less than 20%, and more particularly not less than 26%, by weight of the dough. For example, in some embodiments, potato starch, corn starch or combinations thereof may be present in amounts from about 20% to about 35% by weight of the dough, and more particularly from about 26% to about 30% by weight of the dough. In some embodiments, potato starch may be present in an amount from about 13% to about 15% by weight of the dough and corn starch may be present in an amount from about 12% to about 16% by weight of the dough.

The flour mixture is not a direct substitute for wheat flour. That is, the flour mixture alone does not provide a comparable taste or texture to wheat based doughs and baked products. Rather, additional ingredients are added to the dough to provide structure, flavor and handling properties.

Hydrocolloids or gums, can be added to the dough formulation to give structure to the dough and bind ingredients (i.e., to create a suitable matrix within the dough in the absence of gluten). For example, hydrocolloids may be added to improve the rheology and crumb texture by stabilizing small air cells within the dough and bind to moisture. Hydrocolloids are hydrophilic polymers that contain hydroxyl groups and may be polyelectrolytes. Suitable hydrocolloids may be of vegetable, animal, microbial or synthetic origin. Suitable hydrocolloids include xanthan gum, guar gum, locust bean gum, carrageenan gum and the like. In some embodiments, hydrocolloids or gums may be present in an amount from about 0.2% to about 2% by weight of the dough, and more particularly from about 0.4% to about 1.4% by weight of the dough.

The ready-to-bake dough may also include oil. Suitable oils include vegetable oil, cottonseed oil, nut oil, soybean oil, sunflower oil, rapeseed oil, sesame oil, olive oil, corn oil, safflower oil, palm oil, palm kernel oil, coconut oil, and combinations thereof. Suitable amounts of oil include from about 4.5% to about 5.5% by weight of the dough.

The ready-to-bake dough may further include solid shortening. Animal or vegetable based natural shortenings can be used, as can synthetic shortenings. Shortening is generally comprised of triglycerides, fats and fatty oils that are made predominantly from triesters of glycerol with fatty acids. Fats and fatty oils that may be found in the shortening include cottonseed oil, nut oil, soybean oil, sunflower oil, rapeseed oil, sesame oil, olive oil, corn oil, safflower oil, palm oil, palm kernel oil, coconut oil, and combinations thereof. Suitable animal based shortenings include lard. Other suitable shortenings include pie shortening, which may be a solid, hydrogenated vegetable oil. The shortening may have beneficial effects on the volume, grain and texture of the dough, as well as the texture, mouth feel and other organoleptic properties of the baked product. Suitable amounts of shortening include from about 20% to about 30% by weight of the dough, and more particularly, from about 22% to about 26% by weight of the dough. When the shortening is lard, suitable amounts include from about 20% to about 40% by weight of the dough.

The ready-bake-dough may still further include crystalline fructose. Crystalline fructose is a simple monosaccharide provided in a dried, ground form and that may be derived from several different sources, including sugar cane, sugar beets and corn. It has been found that the addition of fructose may produce a dough having a softer texture and may reduce or eliminate cracking during sheeting of the dough. The softer texture may be caused by fructose absorbing water and plasticing more quickly than other saccharides such as sucrose. For example, fructose as a monosaccharide has a smaller crystal size than disaccharides, which may enable fructose to dissolve more quickly. In some embodiments, fructose may be added directly to the dough without pre-dissolving. In other embodiments, fructose may be dissolved prior to adding it to other ingredients of the ready-to-bake dough. In some embodiments, the dough may include from about 1% to about 4.5% by weight crystalline fructose and more particularly from about 1% to about 4% by weight crystalline fructose.

In some embodiments, the ready-to-bake dough may include other saccharides, such as sucrose and maltodextrin, in combination with or as an alternative to fructose. Similar to fructose, the inclusion of saccharide(s), such as sucrose and/or maltodextrin may produce a dough having a soft texture similar to the texture of wheat flour based doughs and may reduce cracking of the dough during sheeting. The crystalline size of the saccharide may affect the taste, texture and mouth feel of the dough and the finished baked product and the saccharide may be selected to produce a dough and baked good having the desired properties. In some embodiments, the saccharide may be maltodextrin, which consists of glucose units connected in chains of variable length. In addition to the crystalline size, the chain length and/or crosslinking of a saccharide polymer, such as maltodextrin, may affect the taste, texture and mouth feel of the dough and finished baked product. In some embodiments, the ready-to-bake dough may include from about 1% to about 6% by weight of a saccharide in addition to the sucrose described below, and more particularly from about 1% to about 4% by weight.

In some embodiments, the ready-to-bake dough may include a small amount of sucrose. Particularly suitable sucrose includes white sugar, brown sugar and combinations thereof. Pie dough is typically not a sweet dough. For example, the ready-to bake dough may include less than 5% by weight sucrose. In some embodiments, the ready-to-bake dough may include from about 0% to about 5%, from about 1% to about 3% or from about 1% to about 2% sucrose by weight of the dough.

Water may also be included in the ready-to-bake dough. Water may be introduced into a dough by two general means: ingredients (i.e., flour) can contain an amount of water, and water may be added to the dough as a separate ingredient. The water content affects the texture and consistency of the ready-to-bake dough. In some embodiments, it is desired to produce a ready-to-bake dough that has the same texture and consistency as a typical gluten containing dough, i.e., a dough that is workable and that is sufficiently moist to enable the dough to be sheeted with little to no cracking. Suitable amounts of water include from about 20% to about 25% water by weigh of the dough, and more particularly from about 20% to about 22% water by weight of the dough.

The ready-to-bake dough may further include preservatives, such as propionic acid and/or sorbic acid, to improve the shelf stability of the dough. In some embodiments, suitable preservatives include citric acid and potassium sorbate. Suitable amounts of citric acid include from about 0.08% to about 0.12% by weight of the dough and suitable amounts of potassium sorbate include from about 0.04% to about 0.06% by weight of the dough. The pH of the dough affects the preservative effect of propionic acid and sorbic acid. More specifically, the pKa or dissociation constant of propionic acid and sorbic acid varies with pH and thus the amount of acid undissociated or free to act as a preservative varies with the pH of the dough. In some embodiments, at least 20% by weight of the added organic acids are in the undissociated form. For example, in some embodiments, the ready-to-bake dough may include from about 26% to about 28% by weight undissociated propionic acid. Additionally or alternatively, the ready-to-bake dough may include from about 26% to about 28% by weight undissociated sorbic acid.

In some embodiments, the ready-to-bake dough may have a pH of 7 or less, for example, from about 5 to about 6.3. More particularly, the dough may have a pH of 5.3 or less, for example, from about 5 to about 5.3. It has been found that a reduced pH can increase the microbial stability over extended periods of time. In some embodiments, the pH of the ready-to-bake dough may be measured directly using a pH probe. In other embodiments, the pH of the ready-to-bake dough may be determined by measuring the pH of an aqueous based slurry containing 10% dough by weight using a pH probe. Suitable organic acids for reducing the pH of the dough include citric acid.

Salt may be added to the dough formulation. Suitable amounts of salt include from about 0.25% to about 2% by weight of the dough, and more particularly from about 0.5% to about 1.5% by weight of the dough. The salt may be used for flavor purposes and/or to reduce water activity.

In addition to the foregoing, other ingredients known to those of skill in the art can be included in the compositions to give a variety of desired properties, flavors and/or textures. Examples of these ingredients include flavoring and coloring agents, flavors, spices, flavor identifying particulates such as fruit, chocolate, or nuts, and the like.

Water activity is a measure of the equilibrated water vapor pressure generated by the product divided by the vapor pressure of pure water at the same temperature as shown in Formula (1).

a_{w}≡p/p₀ (1)

where p is the vapor pressure of water in the substance, and p₀ is the vapor pressure of pure water at the same temperature. Lowering the water activity provides the microbial stability required to impart shelf stability under refrigerated conditions for extended periods of time (e.g., at least about 75 days or at least about 90 days or up to 120 days),In some embodiments, the dough of the invention has a water activity of less than about 0.94. For example, the dough of the invention may have a water activity of between about 0.93 and 0.94. If the water activity is higher, then microbial stability over extended periods of time is reduced unless the water in the dough is frozen. If the water activity is lower, then the microbial stability under refrigeration temperatures satisfactory, but the amount of water available is so low that the resulting dough may not be capable of being sheeted and the end product may not have a high volume and fluffy texture and may be unacceptably dry.

Exemplary ready-to-bake stable pie dough compositions are provided in Tables 1 and 2 and exemplary gluten-free flour mixtures for use in the pie dough composition are provided in Table 3. All components are provided as weight percent of the dough composition.

TABLE 1
Ready-to-bake pie dough compositions (Formula A)

| | First Range | Second Range |
|---|---|---|
| | (% wt) | (% wt) |
| Gluten-free flour mixture | 31-50% | 39-44% |
| Crystalline fructose | 1-4.5% | 1-4% |
| Sugar | 0-5% | 1-3% |
| Potassium sorbate | 0.08-0.12% | 0.08-0.12% |
| Citric acid | 0.04-0.06% | 0.04-0.06% |
| Hydrocolloids | 0.2-2% | 0.4-1.4% |
| Salt | 0.25-2% | 0.5-1.5% |
| Solid shortening | 20-30% | 22-26% |
| Oil | 4.5-5.5% | 4.5-5.5% |
| Water | 20-25% | 20-22% |

TABLE 2
Ready-to-bake pie dough compositions (Formula B)

| | First Range | Second Range |
|---|---|---|
| | (% wt) | (% wt) |
| Gluten-free flour mixture | 31-50% | 39-44% |
| Crystalline fructose | 1-4.5% | 1-4% |
| Sugar | 0-5% | 1-3% |
| Maltodextrin | 0-1.5% | 0-1.5% |
| Potassium sorbate | 0.08-0.12% | 0.08-0.12% |
| Citric acid | 0.04-0.06% | 0.04-0.06% |
| Hydrocolloids | 0.2-2% | 0.4-1.4% |
| Salt | 0.25-2% | 0.5-1.5% |
| Pie shortening | 0-15% | 0-12% |
| Lard | 20-40% | 20-40% |
| Oil | 4.5-5.5% | 4.5-5.5% |
| Water | 20-25% | 20-22% |

TABLE 3
Gluten-free flour mixtures

| | First Range | Second Range |
|---|---|---|
| | (% wt) | (% wt) |
| Rice flour | 4-15% | 7-9% |
| Potato starch | 13-15% | 13-15% |
| Corn starch | 12-16% | 12-16% |
| Sorghum flour | 4.5-8% | 5-6% |

The ready-to-bake pie dough is prepared by combining the ingredients by stirring in a standard mixer such as a Sigma style mixer or a spiral dough style mixer. Preferably the mixing is carried out under refrigerated conditions, about 35 to 45° F. (1-7° C.). The ingredients may be combined using various methods. In one embodiment, all dry ingredients are blended together. The fat (i.e., shortening) and liquid ingredients are then added to the blended dry components and mixed. Next, a slurry formed with a portion of the water and the preservatives of the formulation. The slurry is added to and mixed with the blended liquid and dry ingredients to form a uniform dough mixture.

After mixing is complete, the dough can be pumped into a filler, and the dough can be placed in suitable containers, such as by extrusion. The containers can be of any desired shape, such as a tub with snap on lid made of a material such as polypropylene, linear low density polypropylene, or other suitable material. The containers need not be hermetically sealed or pressurized to provide the dough with good microbial stability under refrigeration temperatures. A shrink band may be included to provide evidence of tampering.

In some embodiments, the pie dough can be further processed as desired, such as by sheeting with any suitable sheeting apparatus, prior to a packaging process. During the sheeting operation, a dough may be at a temperature to prevent damage, e.g., at least about 55° F. (12.8° C.) to prevent disruption of the continuous sheet, and a temperature that does not exceed 75° F. (23.9° C.). Also during sheeting, if desired, the dough surface can be dusted with an anti-sticking material, such as the gluten-free flour mixture or one or more of the rice flour and/or sorghum flour, to prevent sticking of the dough surface to rolls of the sheeting apparatus. In some embodiments, the dough may be sheeted to a thickness in the range from 1/16 of an inch to ⅜ of an inch (0.16 cm to 0.95 cm).

The sheeted dough can be cut and rolled by any useful conventional or future-developed methods, such as by hand or by use of automated equipment. In some embodiments, the dough may be cut into a circular pie crust prior to being rolled-up. Suitable diameters for the cut pie crust include from about 10 to about 12 inches (25.4 cm to 30.5 cm).

The rolled-up dough can be packaged in a desired package, such as tube package that is of a shape that approximates the shape of the rolled up dough. The package may include plastic, paper or polymeric materials, such as a paper or cardboard box or a plastic box that contains one or multiple rolled-up doughs. One example of a useful package type can be a tube- or sleeve-like package in the form of a rigid or flexible, elongate, cylindrical body that can contain more or more rolled-up doughs. A flexible body may be of any useful or desired shape, including a cross-section that is a square, angular, rounded, circular, oval, rectangle or triangle. The flexible body may be formed from any flexible material useful for packaging, such as a coated or uncoated polymeric or paper material and may have barrier properties to one or more of oxygen, carbon dioxide, or moisture, to allow the refrigerated dough to retain freshness and exhibit storage stability and a desired shelf life. Optionally, a package that includes a flexible outer body can include a more stiff or rigid material such as a cardboard or plastic tray inside the flexible wrapper to support the dough.

The dough described herein and the resulting baked product has a taste, texture and rheology similar to that of typical gluten containing doughs. As describe herein, gluten creates a matrix or structure in a dough through a network of gluten strands. This matrix affects the viscosity and processability of the dough. For example, the gluten matrix is similar to an emulsifying agent which keeps the fats, oils and sugars of the dough together in the dough and prevents separation. The extent of the network of gluten strands impacts whether a mixture is thin and runny, like a batter, or is thick, like a dough. The elimination of gluten removes the gluten matrix. However, it has been found that the components of the gluten-free pie dough described herein provide suitable structure in the dough. For example, egg solids, hydrocolloids or gums and potato starch have been found to improve the structure of the present gluten-free pie dough. It has also been found that a suitable texture, such as a texture that is not overly gritty, can be achieved by including less than 15% rice flour by weight of the dough.

The dough of the current invention has a rheology similar to that of typical gluten containing doughs. That is, the dough described herein has a satisfactory viscosity and is sufficiently moist to enable the dough to be rolled or formed into balls for baking. Further, the dough described herein is acceptable for commercial production, enabling the dough to be formed in large scale batches, and pumped and extruded into containers for commercial sale.

In some embodiments, the hardness or the ease with which the dough spreads can be determined by a spread test using a texture analyzer. Suitable texture analyzers are available from Stable Micro Systems, United Kingdom, and may be equipped with a TTC spreadability rig also available from Stable Micro Systems. In some embodiments, a dough sample is placed into a female cone-bottomed cylinder of the texture analyzer. A precisely-matching male cone can then be lowered into the sample, forcing the sample to flow upwards and outwards. The force required to move the male cone at a constant rate is measured. The measured force is an indication of the ease with which the sample flows, and the spreadability or hardness of the sample. Suitable force measurements for a spread test can be from about 5,000 to about 14,000 grams force, and more particularly from about 5,000 to about 6,500 grams force.

The extruded dough is workable under normal refrigeration conditions, generally about 35-45° F. (1-7° C.). By “workable”, it is meant that the consumer can readily remove the dough from the container, roll and/or shape the dough, for example into a pie crust. The dough of the invention can be removed from the refrigerator and baked into high-quality baked foods such as pie crusts. The dough is simply removed from the container onto a baking pan and baked under normal conditions, e.g., in a 350-375° F. (176-191° C.) oven for a sufficient amount of time to fully cook the product.

The dough is shelf stable for at least about 90 days under refrigerated conditions. By shelf stable it is meant that the dough maintains a desired texture, appearance and taste and produces a baked product having a desired taste, texture and mouth feel. For example, the dough will retain its leavening properties and microbial stability for at least about 90 days under refrigerated conditions.

The dough bakes into a baked product that has a taste, texture, and mouth feel similar to that of a gluten containing baked product. As described herein, gluten is responsible for the texture and taste of gluten containing (e.g., wheat flour based) baked goods such as cookies, brownies, pie crusts and breads. Upon hydration, gluten forms a network of fine strands that give the dough the capacity to stretch and/or rise during baking. The elasticity of gluten enables the dough to trap gases, which create open cellular structures upon baking. The gluten-free flour mixture and other ingredients of the dough described herein mimic the functionality of gluten such that the resulting baked product has a color, rise, spread, texture, flavor and/or mouth feel similar and/or comparable to a gluten containing baked product.

### EXAMPLES

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

### Formation of Gluten-Free, Ready-to-Bake Pie Dough

Pie dough was prepared by combining all dry ingredients in a spiral dough style mixer and blending to achieve a uniform mixture. Solid shortening and liquid ingredients were added to the blended dry components and mixed. A small amount of water was reserved from the liquid ingredients in order to form a slurry with the preservatives of the formulation. After the liquid and dry components were mixed to achieve a uniform mixture, a slurry of the reserved water and the preservatives was added and the composition was again mixed to achieve a uniform dough product. The mixing was carried out under refrigerated conditions, about 35 to 45° F. (1-7° C.).

### Texture Analysis (Margarine Spread Test)

A dough sample was placed into a texture analyzer having a female cone-bottomed cylinder. Suitable texture analyzers are available from Stable Micro Systems, United Kingdom, and may be equipped with a TTC spreadability rig also available from Stable Micro Systems.A precisely-matching male cone was lowered into the sample, forcing the sample to flow upwards and outwards. The force required to move the male cone at a constant rate was measured. The measured force is an indication of the ease with which the sample flows, and the spreadability or hardness of the sample.

### Control Formulation

The Control Formulation is provided in Table 4 and included 51.2% by weight liquid components and 48.81% by weight dry components. The total amount of fat (liquid and solid) was 41.26% by weight of the composition and the flour mixture accounted for 41.26% by weight of the composition.

TABLE 4
Control Formulation

| Ingredient | % wt |
|---|---|
| White Rice Flour | 7.67 |
| Potato Starch | 13.91 |
| Corn Starch | 14.39 |
| Sorghum Flour | 5.29 |
| Fructose | 3.5 |
| Granulated Sugar | 1.75 |
| Potassium Sorbate | 0.1 |
| Sodium Propionate | 0.1 |
| Citric Acid | 0.05 |
| Xanthan Gum | 0.5 |
| Guar Gum | 0.1 |
| Salt | 1.45 |
| Pie shortening | 25 |
| Soybean Oil | 5.05 |
| Slurry Water | 5.29 |
| Cold Water | 15.86 |

The Control Formulation had a force reading of 5,744.0 grams force under the texture analysis test described above.

### Examples 1 and 2

### Shortening

Table 5 provides the compositions for Examples 1 and 2. Example 1 had a decreased amount of shortening and Example 2 had an increased amount of shortening as compared to Control Formulation.

TABLE 5
Examples 1 and 2

| | Example 1 | Example 2 |
|---|---|---|
| Ingredient | % wt | % wt |
| White Rice Flour | 7.901 | 7.439 |
| Potato Starch | 14.330 | 13.490 |
| Corn Starch | 14.824 | 13.956 |
| Sorghum Flour | 5.450 | 5.130 |
| Fructose | 3.606 | 3.394 |
| Granulated Sugar | 1.803 | 1.697 |
| Potassium Sorbate | 0.103 | 0.097 |
| Sodium Propionate | 0.103 | 0.097 |
| Citric Acid | 0.052 | 0.048 |
| Xanthan Gum | 0.515 | 0.485 |
| Guar Gum | 0.103 | 0.097 |
| Salt | 1.494 | 1.406 |
| Pie shortening | 22.738 | 27.262 |
| Soybean Oil | 5.202 | 4.898 |
| Slurry Water | 5.450 | 5.130 |
| Cold Water | 16.338 | 15.382 |

Example 1 and Example 2 were subjected to the texture analysis. Example 1 had a force of 10,622.6 grams force and Example 2 had a force of 17,495.0 grams force. By comparing Examples 1 and 2 to the Control Formulation, it is seen that either an increase or a decrease in the shortening content affected the ease with which the dough could be compressed or spread. More specifically, it is seen that either increasing or decreasing the shortening content as compared to the Control Formulation produced a dough that was more difficult to compress or spread.

### Examples 3 and 4

### Water

Example 3 had a decreased amount of water and Example 4 had an increased amount of water as compared to the Control Formulation. The compositions of Example 3 and Example 4 are provided in Table 6.

TABLE 6
Examples 3 and 4

| | Example 3 | Example 4 |
|---|---|---|
| Ingredient | % wt | % wt |
| White Rice Flour | 7.715 | 7.625 |
| Potato Starch | 13.992 | 13.828 |
| Corn Starch | 14.475 | 14.305 |
| Sorghum Flour | 5.321 | 5.259 |
| Fructose | 3.521 | 3.479 |
| Maltodextrin | 0.000 | 0.000 |
| Granulated Sugar | 1.760 | 1.740 |
| Potassium Sorbate | 0.101 | 0.099 |
| Sodium Propionate | 0.101 | 0.099 |
| Citric Acid | 0.050 | 0.050 |
| Xanthan Gum | 0.503 | 0.497 |
| Guar Gum | 0.101 | 0.099 |
| Salt | 1.459 | 1.441 |
| Pie shortening | 25.148 | 24.852 |
| Soybean Oil | 5.080 | 5.020 |
| Slurry Water | 5.321 | 5.259 |
| Cold Water | 15.362 | 16.358 |

Example 3 and Example 4 were subjected to the texture analysis. Example 3 had a force of 13,608.4 grams force and Example 4 had a force of 14,458.2 grams force. Examples 3 and 4 demonstrate that a change in water content of the dough affects how easily the dough can be compressed. More specifically, it is seen that either increasing or decreasing the water content as compared to the Control Formulation produced a dough that was more difficult to compress.

### Example 5

### Lard

As shown in Table 7, Example 5 included pie shortening and lard.

TABLE 7
Example 5

| | Example 5 |
|---|---|
| Ingredient | % wt |
| White Rice Flour | 8 |
| Potato Starch | 14.5 |
| Corn Starch | 14.749 |
| Sorghum Flour | 5.5 |
| Fructose | 1.5 |
| Granulated Sugar | 1.5 |
| Potassium Sorbate | 0.1 |
| Sodium Propionate | 0.1 |
| Citric Acid | 0.05 |
| Xanthan Gum | 0.5 |
| Guar Gum | 0.1 |
| Salt | 1 |
| Pie shortening | 11.25 |
| Shortening-Lard | 20 |
| Cold Water | 21.15 |

Example 5 was subjected to the texture analysis. Example 5 had a force of 14,506.8 grams force. Comparing Example 5 to the Control Formulation, it is seen that the substitution of a portion of pie shortening with lard produces a dough that is more difficult to compress (i.e., a dough that requires a larger force to compress).

### Comparative Formulation A

Comparative Formulation A was a gluten-free pie crust dry box mix available from Betty Crocker. The pie crust was prepared according to the instructions provided on the box. The texture analysis produced a force of 3,711.3 grams force. Compared to the Control Formulation, which was a ready-to-bake gluten-free pie crust, Comparative Formulation A was easier to compressor or spread.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A composition comprising:
a gluten-free flour mixture in an amount from 31to 50% by weight of the composition, the gluten-free flour mixture including less than 15% rice flour by weight of the composition and at least one of sorghum flour, potato starch, corn starch and combinations thereof;
at least one oil in an amount from 4.5% to 5.5% by weight of the composition;
shortening in an amount from 20% to 30% by weight of the composition;
fructose in an amount from 1% to 4.5% by weight of the composition;
water from 20% to 25% by weight of the composition; and
sucrose in an amount of less than 5% by weight of the composition,
wherein the composition has a water activity of 0.94 or less and a pH of 7 or less.

2. The composition of claim 1, further comprising at least one gum in an amount from 0.2% to 2% by weight of the composition.

3. The composition of claim 2, wherein the gum includes at least one member selected from the group consisting of: xanthan gum and guar gum.

4. The composition of claim 1, further comprising sucrose in an amount from 1% to 3% by weight of the composition.

5. The composition of claim 1, wherein the composition comprises from 4% to 15% rice flour by weight of the composition.

6. The composition of claim 1, wherein the composition further comprises from 4.5% to 8% sorghum flour by weight of the composition.

7. The composition of claim 1, wherein the composition further comprises from 20% to 35% by weight of the composition of at least one starch selected from the group consisting of potato starch and corn starch.

8. The composition of claim 7, wherein the composition further comprises from 13% to 15% potato starch by weight of the composition.

9. The composition of claim 7, wherein the composition further comprises from 12% to 16% corn starch by weight of the composition.

10. The composition of claim 1, wherein the composition is free of gluten.

11. The composition of claim 1, wherein the composition further comprises propionic acid, of which at least 20% is in an undissociated form.

12. The composition of claim 1, wherein the composition further comprises sorbic acid, of which at least 20% is in an undissociated form.

13. A method of manufacturing a composition, the method comprising:
combining:
a gluten-free flour mixture in an amount from 31% to 50% by weight of the raw dough product, the gluten-free flour mixture including less than 15% rice flour by weight of the raw dough product and at least one of sorghum flour, potato starch, corn starch and combinations thereof;
at least one oil in an amount from 4.5% to 5.5% by weight of the raw dough product;
shortening in an amount from 20% to 30% by weight of the raw dough product;
fructose in an amount from 1% to 4.5% by weight of the raw dough product;
water from 20% to 25% by weight of the raw dough product and sucrose in an amount of less than 5% by weight of the raw dough product,
forming a raw dough product; and
packaging the raw dough product, wherein the raw dough product has a water activity of 0.94 or less and a pH of 7 or less.

14. The method of claim 13, and further comprising:
sheeting the raw dough product before packaging; and
cutting the sheeted raw dough product before packaging.

15. The method of claim 13, wherein packaging includes extruding the raw dough product into a packaging container.

16. The method of claim 13, wherein the raw dough product is free of gluten.
